(19) United States
(12) Patent Application Publication
(10) Pub. No.: US 2014/0009545 A1
(43) Pub. Date: Jan. 9, 2014

(54) CONDUCTIVE INK FORMULAS FOR IMPROVED INKJET DELIVERY

(71) Applicant: INTRINSIQ MATERIALS, Rochester, NY (US)

(72) Inventor: Michael J. Carmody, Webster, NY (US)

(73) Assignee: INTRINSIQ MATERIALS, Rochester, NY (US)

(21) Appl. No.: 13/718,121

(22) Filed: Dec. 18, 2012

Related U.S. Application Data
(60) Provisional application No. 61/668,518, filed on Jul. 6, 2012.

(51) Int. Cl. C09D 11/00

(52) U.S. Cl. CPC C09D 11/30
USPC 347/100; 252/512

(57) ABSTRACT

An ink composition for printing conductive layers on a variety of substrates is disclosed. The ink composition comprises polymer encapsulated copper nanoparticles, a primary glycol solvent, an alcohol and a diol monoether. The inventive ink is characterized by excellent jettability and freedom from nozzle-plate flooding. Ink surface tensions are in the range of 34 to 37 mN/m and viscosities are less than 41 cP.

### CROSS-REFERENCE TO RELATED APPLICATIONS

This application claims the benefit of U.S. Provisional Patent Application No. 61/668,518, entitled “Conductive Ink Formulas for Improved Inkjet Delivery”, filed Jul. 6, 2012, the disclosure of which is incorporated by reference herein in its entirety.

### FIELD OF THE INVENTION

The invention relates to compositions for low cost, air stable, copper conductive inks and to methods for their use.

### BACKGROUND OF THE INVENTION

In the electronics industry, there is a desire for producing conductive traces on flexible or rigid, planar and even non-planar substrates for application in devices such as display devices, solar cells, computers, and RFID tags. Conductive traces on rigid and planar substrates have been typically manufactured by subtractive photolithographic processes. More recently, it has been recognized that additive deposition processes can be advantageous for a number of reasons. For example, additive deposition of conductive traces can reduce the number of steps involved in processing. It can also reduce the number and amount of materials required, lowering cost and reducing environmental impact. Additive deposition is also generally more suitable than more conventional techniques for use with flexible substrates, and can enable printing of non-planar substrates. Additive deposition of conductive inks can involve applying metallic nano-particulate inks onto a substrates and photonically sintering the deposited ink to form the conductive traces.

Various processes have been used to produce conductive patterns such as inkjet printing, screen printing, aerosol jet, flexographic printing and gravure printing. Inkjet printing is particularly advantageous because it is flexible and commercial equipment is available for printing high-solids inks on a variety of substrates. Inkjet inks must have physical properties that allow them to be readily and reproducibly jetted while printing well on substrates of interest. The inks must be formulated therefore, to be compatible with the inkjet process. Considerations include preventing undesirable fouling of the inkjet nozzle-plate and compatibility with the substrate receiving surface properties. Finding a balance of these properties is challenging, especially when using high-solids inks that comprise polymers.

A number of metals have been considered for use in nanoparticle conductive inks.

Noble metals like gold and silver are advantaged for their conductivity and their air stability; however their cost can be prohibitive for many applications. Copper has excellent conductivity and significantly lower cost; however, it oxidizes readily wherein its conductivity is significantly diminished. To reduce the loss of conductivity caused by oxidation, means of air passivation have been employed, particularly for copper inks based on nanoparticles. The air stabilization can be achieved by using a bimetallic core-shell conductive particle approach where, for example, the copper core is covered with a silver shell. Alternatively, copper nanoparticles can be air stabilized by using polymer shells that are eventually removed in the sintering process that forms the conductive traces.

Regarding the challenge of balancing properties required for inkjet ink formulations, copper nano-particle inkjet inks are particularly troublesome because of the amount of copper required to produce conductive traces and because of the polymer shell needed around the copper in order to disperse it in solvents and to protect it from aerial oxidation.

What is needed is a formulation of ink and associated deposition process that can reliably deposit traces with desired properties on various substrates of interest, while having appropriate wetting characteristics for the nozzle-plate of the printhead.

### SUMMARY OF THE INVENTION

The invention is directed to compositions of copper inks, the compositions enabling their use for inkjet printing, such that the inks exhibit good printing performance with respect to droplet formation and ejection, reduced nozzle-plate wetting and flooding, and compatibility with substrates of interest.

In one aspect, the invention relates to an ink composition which improves jetting of polymer protected copper nano-particle inks by reducing viscosity while improving the wetting characteristics on the nozzle-plate of the printhead, wherein the composition comprises copper nanoparticles having polymer shells, and a combination of solvents including a primary glycol, an alcohol, and a diol monoether.

In another aspect, the invention is directed at compositions according to the first aspect, and wherein the solvents and their ratios are chosen to yield inks having viscosities less than about 41 centipoise (cP) and surface tensions between about 34 and 37 milli-newtons per meter (mN/m).

In yet another aspect, the invention relates to compositions according to the first aspect wherein lower loading of polymer is achieved while maintaining improved nozzle-plate wetting characteristics and passivation of the copper nanoparticles.

In a further aspect, the invention is directed to a process for jetting copper nanoparticle inks wherein physical ink fluid parameters are tuned via ink composition such that inks are readily and reproducibly jetted while ink jet nozzle-plate flooding is greatly reduced or eliminated.

These and other aspects, objects, features and advantages of the present invention will be more clearly understood and appreciated from a review of the following detailed description of the preferred embodiments and appended claims, and by reference to the accompanying drawings.

### BRIEF DESCRIPTION OF THE DRAWINGS

FIG. 1A is a micrograph showing severe nozzle-plate flooding after jetting with ink, using a conventional ink composition having copper nanoparticles with polymer shells.

FIG. 1B is a micrograph showing a clean nozzle-plate, after jetting using an inventive ink wherein the copper nanoparticles with polymer shells were from the same source as those used in the ink composition of FIG. 1A.

FIG. 2A is a micrograph showing severe nozzle-plate flooding after jetting with ink, using a conventional copper nanoparticle ink composition, the composition characterized by a lower polymer content for copper nanoparticle polymer shells.

FIG. 2B is a micrograph showing a clean nozzle-plate, after jetting using an inventive ink wherein the copper nanoparticles with polymer shells were from the same source as those used in the ink composition of FIG. 2A.

FIG. 3 is a plot of resistances for sintered copper traces made from both comparative and inventive inks on two different substrates.

FIGS. 4A and 4B are images of sintered copper traces produced using Comparative Ink G and Inventive Ink H, respectively.

### DETAILED DESCRIPTION OF THE INVENTION

The present description is directed in particular to elements forming part of, or cooperating more directly with, apparatus in accordance with the invention. It is to be understood that elements not specifically shown or described may take various forms well known to those skilled in the art. The present invention relates to ink formulations that improve jetting of polymer protected copper nano-particles by reducing viscosity while improving the wetting characteristics on the nozzle-plate of the printhead.

In an exemplary embodiment of the present invention, a conductive ink composition includes about 8-15% of a copper nano-powder protected by a shell of nonionic polymer, a primary glycol solvent comprising no less than 50% of the solvent mixture, a mono-hydroxy solvent comprising four or more carbon atoms, and a diol monoether. The identities and amounts of the hydroxyl solvent and the diol monoether are varied to give viscosities less than 41 cP and surface tensions between 34 and 37 mN/m. The values of the physical fluid parameters viscosity and surface tension, discussed herein, refer to values measured at 20 degrees C.

In the context of the present disclosure, nanoparticle size refers to actual geometric size, as determined, for example, by Transmission Electron Microscopy. Copper nanoparticles useful for the purposes of the invention include those having diameters less than 200 nm, the upper size range limited by inkjet printhead requirements. In some embodiments, copper nanoparticles as small as 20 nm are useful. The inventive copper nanoparticulate inks may comprise nanoparticles having substantially monodisperse copper nanoparticle size distributions. Other embodiments may comprise copper nanoparticles characterized by polydisperse size distributions having sizes substantially within the stated limits. Copper nanoparticle loading in ink compositions for the purpose of the invention, that is, their weight fraction, is in the range of 5% to 17% by weight.

The particular polymer shell material is chosen to aid in the dispersion of the copper core/polymer shell nanoparticles and to passivate the copper nanoparticles against degradation by reaction with components in the ambient. Useful polymers for this purpose include, but are not limited to, polyvinylpyrrolidone (PVP), polyvinyl alcohol, methyl cellulose, polyethylene glycol, polyacids such as polyacrylic acid, polymethylmethacrylate, polymaleic acid, and the like. In some embodiments, the weight fraction of polymer in the core/shell nanoparticle is in the range of about 5% to about 14%.

The primary glycol solvent choice includes but is not limited to ethylene glycol, propylene glycol, and, 1,2-dihydroxybutane.

The choice of mono hydroxyl solvents includes but is not limited to the primary alcohols butanol, amyl alcohol, hexanol, heptanol, and octanol and their secondary, tertiary and branched isomers. The inventive formulations include one or more diol monoethers, including glycol monoethers. The diol monoethers useful for the purposes of the invention include 1-methoxy-2-propanol, 2-methoxy-ethanol, 2-ethoxy-ethanol, and, 2-butoxy-ethanol.

In an embodiment of the present invention, inks are prepared that comprise about 12% of a 50 nm copper powder, wherein each copper nanoparticle of the powder is coated with a nonionic polymer. The polymer coated copper nanoparticles comprise about 14% polymer by weight. The nanoparticles are dispersed in a solvent mixture comprising about 60% by weight ethylene glycol with the remaining solvents comprising 1-butanol and 1-methoxy-2-propanol. Dispersion is effected by a high speed mixer with subsequent sonication. Alternative dispersal means, well known in the art may also be employed, for example, ball milling. Ink dispersions are typically filtered as a part of the inkjet ink preparation process. Jettability can be tested using printheads or printers, for example, the Dimatix DMP printer equipped with a disposable print head/cartridge combination. Printheads are mated with drop watching stroboscopic cameras for observing jetting and nozzle wetting. Excellent drop formation and nozzle-plate wetting behavior were observed. Ink surface tension is above 34 mN/m.

According to an alternate embodiment of the present invention, the polymer fraction is varied downward such that only about 5% to 6% of the nanoparticle mass comprises polymer shell. Again it is observed that the inventive solvent combinations and process yields ink compositions having good droplet formation and excellent freedom from nozzle-plate wetting. Again, use of conventional solvent systems is observed to give ink compositions having nozzle-plate wetting problems. Notably, the viscosities for the inventive and the conventional compositions incorporating the reduced polymer fraction of 5-6% are virtually the same.

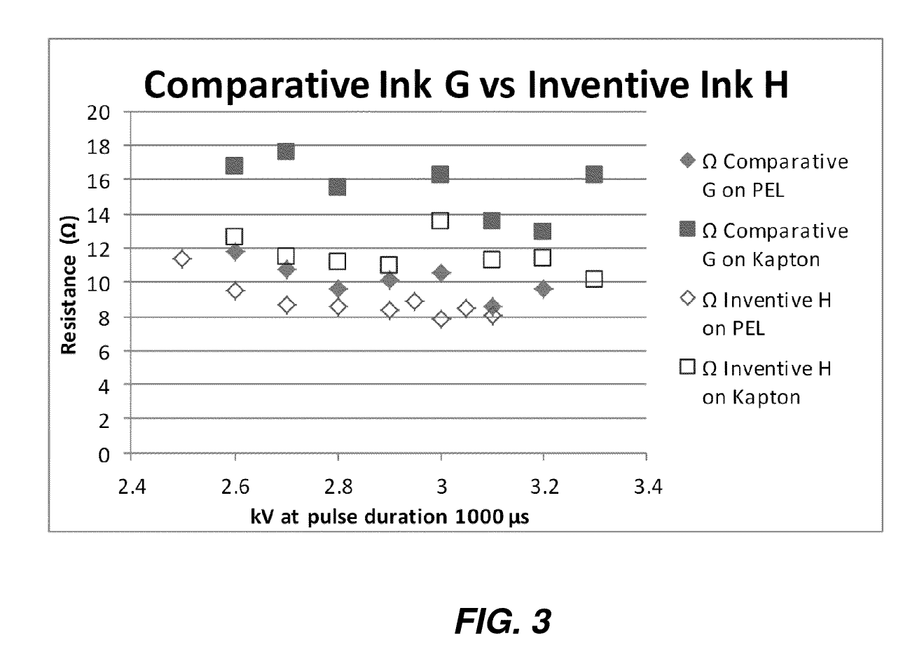

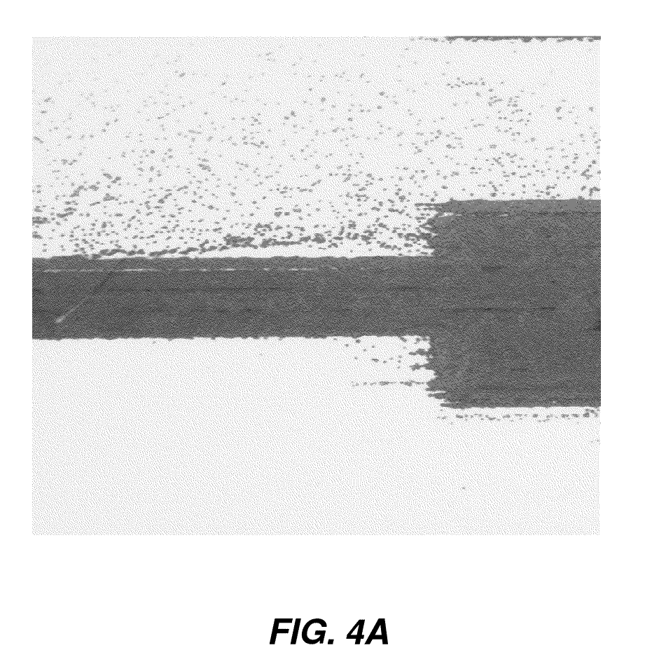

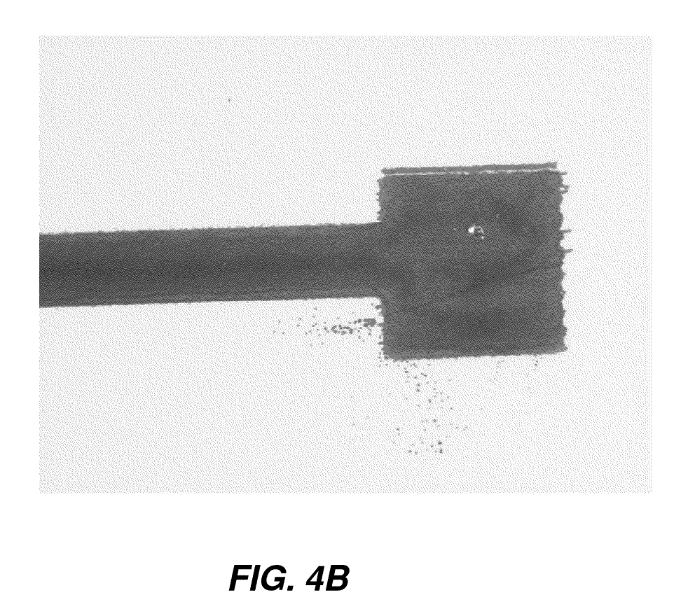

Nozzle-plate wetting leads to problems including but not limited to printing errors, principally the formation of spurious misdirected droplets that deposit conductor material where only insulating substrate is desired. The misdirected printed conductor material can cause electrical shorting between traces. Nozzle-plate wetting also leads to a loss of pattern edge quality, and reduces trace conductor spatial uniformity. An improvement of trace conductivity (lower resistance) for the inventive ink vs. a comparative ink has been observed as well, as is shown in FIG. 3. A comparison of trace pattern quality for inventive and comparative inks is shown in FIGS. 4B and 4A respectively. Improved pattern edge quality and improved spatial uniformity within the copper trace (improved intra-pattern spatial uniformity) can be seen for the traces prepared using the inventive ink.

It has been found by the inventors that, for ink compositions formulated as described above wherein the ink surface tensions are within the range of 34 to 37 mN/m and wherein ink viscosities are below 41 cP, ink jetting is reliable and reproducible and that there is freedom from the problem of nozzle-plate flooding that has been widely observed with conventional formulations. The inventive ink compositions in combination with known ink jet printing equipment enable the reliable printing of conductive traces on a variety of substrates, including flexible substrates such as plastic and paper for example, and at low cost.

### EXAMPLE 1

### Nozzle Plate Flooding

Ink composition Comparative A was prepared using copper-containing Powder Batch A. The ink having 12.3% of the PVP-coated 50.5 nm copper powder was prepared according to the following procedure. The polymer coated copper nanoparticles comprise about 9% PVP polymer by weight. The nanoparticles were dispersed in a solvent mixture comprising 70% by weight ethylene glycol with the remaining solvent comprising 1-butanol. Dispersion was effected by slowly adding powder to the solvent mixture using a high speed disperser. After one hour, the mixture was placed in a sonic bath for 30 minutes, then filtered through a 1.2 micron cartridge filter. Jettability was tested using a Dimatix DMP printer equipped with a disposable print head/cartridge combination. Print heads are mated with drop watching stroboscopic cameras for observing jetting and nozzle wetting.

Ink composition Comparative B was prepared using copper-containing Powder Batch B. The ink having 12.3% of a 50.5 nm copper powder coated with PVP was prepared according to the following procedure. The polymer coated copper nanoparticles comprise about 11% PVP polymer by weight. The nanoparticles were dispersed in a solvent mixture comprising 70% by weight ethylene glycol with the remaining solvent comprising 1-butanol. Dispersion was effected by slowly adding powder to the solvent mixture using a high speed disperser. After one hour, the mixture was placed in a sonic bath for 30 minutes, and filtered through a 1.2 micron cartridge filter. Jettability was tested using a Dimatix DMP printer equipped with a disposable print head/cartridge combination. Print heads are mated with drop watching stroboscopic cameras for observing jetting and nozzle wetting.

An ink composition Inventive A was prepared that comprised 12.3% of a 50.5 nm copper powder coated with PVP from Powder Batch B. The polymer coated copper nanoparticles comprise about 10.7% polymer by weight. The nanoparticles were dispersed in a solvent mixture comprising 59.2% by weight ethylene glycol with the remaining solvent comprising 7.4% 1-butanol and 21.1% 1-methoxy-2-propanol. Dispersion was effected by slowly adding powder to the solvent mixture using a high speed disperser. After one hour, the mixture was placed in a sonic bath for 30 minutes, then, filtered through a 1.2 micron cartridge filter. Jettability was tested using a Dimatix DMP printer equipped with a disposable print head/cartridge combination. Print heads are mated with drop watching stroboscopic cameras for observing jetting and nozzle wetting.

An ink composition Inventive B was prepared that comprised 12.3% of a 50 nm copper powder coated with PVP from Powder Batch C. The polymer coated copper nanoparticles comprise about 12.4% PVP polymer by weight. The nanoparticles were dispersed in a solvent mixture comprising 64.2% by weight ethylene glycol with the remaining solvent comprising 8.4% 1-butanol and 15% 1-methoxy-2-propanol. Dispersion was effected by slowly adding powder to the solvent mixture using a high speed disperser. After one hour, the mixture was placed in a sonic bath for 30 minutes, then filtered through a 1.2 micron cartridge filter. Jettability was tested using a Dimatix DMP printer equipped with a disposable print head/cartridge combination. Print heads are mated with drop watching stroboscopic cameras for observing jetting and nozzle wetting.

Nozzle plate flooding was visually assessed on the Dimatix DMP printer using a qualitative scale (poor, fair, good, very good, excellent). The results of the nozzle-plate flooding test for the 2 comparative conventional compositions (Comp. A and Comp. B) and the 2 inventive compositions (Inv. A and Inv. B) are shown in Table 1. The printing protocol for each experiment in TABLE 1 was the same.

TABLE 1

| | | % | | % 1- | Surface | Nozzle |
|---|---|---|---|---|---|---|
| | Powder | Ethylene | % 1- | methoxy-2- | Tension | Plate |
| Ink | Batch | Glycol | butanol | propanol | (mN/m) | Flooding |
| Comp. A | A | 70 | 17.7 | 0 | 33.27 | Fair |
| Comp. B | B | 70 | 17.7 | 0 | 32.91 | Poor |
| Inv. A | B | 59.2 | 7.4 | 21.1 | 34.45 | Excellent |
| Inv. B | C | 64.2 | 8.4 | 15.0 | 34.84 | Very Good |

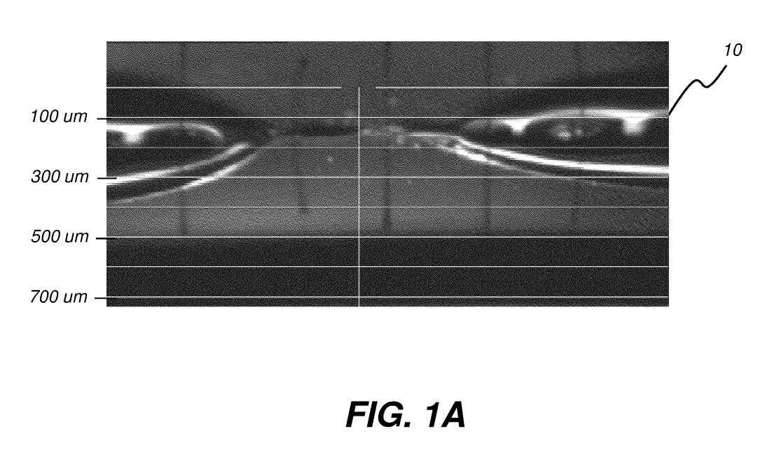

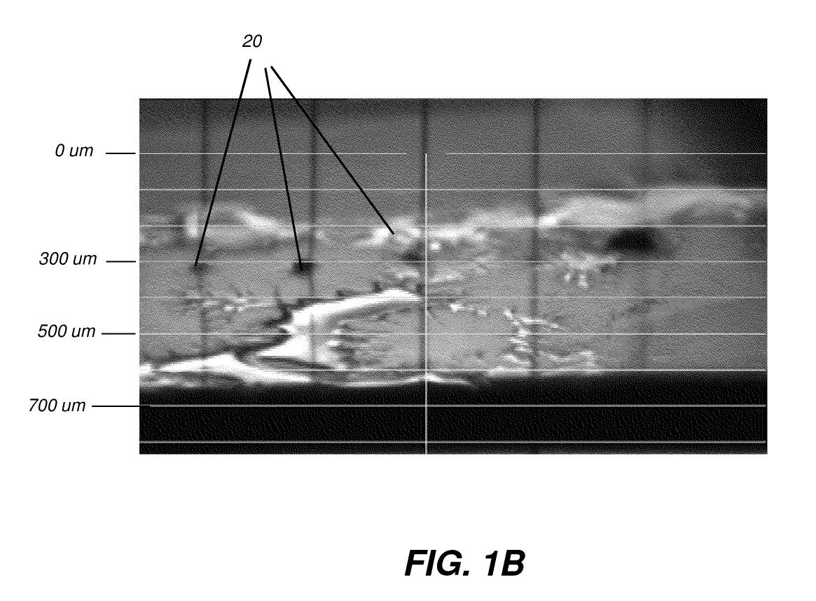

FIG. 1A is an image of the nozzle-plate surface after jetting using the Comparative B ink composition. Note the large surface puddles 10, at the nozzle orifice locations. FIG. 1B is a corresponding image for the ink composition Inventive A. The compositions corresponding to FIGS. 1A and 1B were produced using nanoparticle materials from the same batch. There is observed an absence of puddling of ink at the nozzle orifices, 20. The inventive inks can advantageously provide surface tension greater than or equal to 34 mN/m.

### EXAMPLE 2

### Jettability

Two compositions of comparative inks, Comparative C and Comparative B (same ink as used in EXAMPLE 1, Comparative B) were made from two different batches of copper-containing powder that comprised different amounts of protective PVP polymer. Comparative ink B was prepared using Powder B (same as Powder B of EXAMPLE 1), the powder characterized as having about 10.7% PVP by weight. Ink Comparative C was prepared using Powder D, the powder characterized as having 13.1% PVP by weight and 49.9 nm average copper nanoparticle size. The inks were formulated according to the procedure outlined in Example 1 for the Comparative inks.

Two compositions of Inventive inks (A and C), were made from two different batches of copper-containing powder that comprised different amounts of protective PVP polymer, using Powders B and D respectively, as described for the comparative examples above. The inks were then formulated according to the procedure outlined in Example 1 for the Inventive inks. Details of the ink compositions are given in TABLE 2.

TABLE 2

| | | | % | | % 1- | | Nozzle |
|---|---|---|---|---|---|---|---|
| | Powder | % PVP | Ethylene | % 1- | methoxy-2- | Viscosity | Plate |
| Ink | Batch | in Powder | Glycol | butanol | propanol | (cP) | Flooding |
| Comp. C | D | 13.1 | 70 | 17.7 | 0 | 48.65 | Would not jet |
| Comp. B | B | 10.7 | 70 | 17.7 | 0 | 40.79 | Good |
| Inv. A | B | 10.7 | 59.2 | 7.4 | 21.1 | 33.05 | Excellent |
| Inv. C | D | 13.1 | 59.2 | 7.4 | 21.1 | 40.49 | Good |

As summarized in TABLE 2, Inventive inks clearly show improved viscosity and, hence, improved jettability compared to inks made from the same copper-containing powder, but which lack one of the inventive components. Inks which fire well have viscosities below 41 cP. It was observed that ink Comparative C would not jet at all.

### EXAMPLE 3

### Balancing Viscosity and Surface Tension

Three test inks were prepared from the Powder Batch B of copper-containing powder described in EXAMPLE 1 and using 59.2% of ethylene glycol. The amounts of 1-butanol and 1-methoxy-2-propanol were varied. These inks were not filtered and so were not tested for jetting quality.

TABLE 3

| | | Surface Tension | |
|---|---|---|---|
| Test Ink | % 1-methoxy-2-propanol | (mN/m) | Viscosity (cP) |
| 1 | 24.3 | 34.75 | 39.77 |
| 2 | 22.1 | 34.07 | 37.01 |
| 3 | 20.1 | 33.45 | 35.57 |

It is seen that with the addition of increasing amounts of the monoether alcohol, 1-methoxy-2-propanol, surface tension and viscosity both increase, and that Test Ink 3 has a surface tension which falls outside the 34 to 37 mN/m range. It is thus possible to prepare inks using a combination of all of the three classes of inventive constituents and still be outside the surface tension range that appears to be most advantageous.

### EXAMPLE 4

### Lower Polymer Content in the Copper/Polymer shell Powder

Inks wherein the polymer (PVP) content of the copper nanoparticles with PVP shell was reduced to 5.68% polymer by weight were used in both a Comparative ink composition, and in an Inventive ink composition.

Ink composition Comparative E (Comp. E) was prepared using Copper nanoparticle Powder Batch E. Powder Batch E is characterized as having 5.68% PVP by weight and 53.4nm average copper nanoparticle size. Ink Comparative E was prepared according to the following procedure. The nanoparticles were dispersed in a solvent mixture comprising 70% by weight ethylene glycol with the remaining solvent comprising 1-butanol. Dispersion was effected by slowly adding powder to the solvent mixture using a high speed disperser. After one hour, the mixture was placed in a sonic bath for 30 minutes, and filtered through a 1.2 micron cartridge filter. Jettability was tested using a Dimatix DMP printer equipped with a disposable print head/cartridge combination. Print heads are mated with drop watching stroboscopic cameras for observing jetting and nozzle wetting.

Inventive ink composition F (Inv. F) was prepared using Powder Batch E according to the same procedure as Comparative ink E except that the solvent mixture was composed of ethylene glycol, 1-butanol, and 1-methoxy-2-propanol whose weight percentages were 59.2, 7.4, and 21.1 respectively.

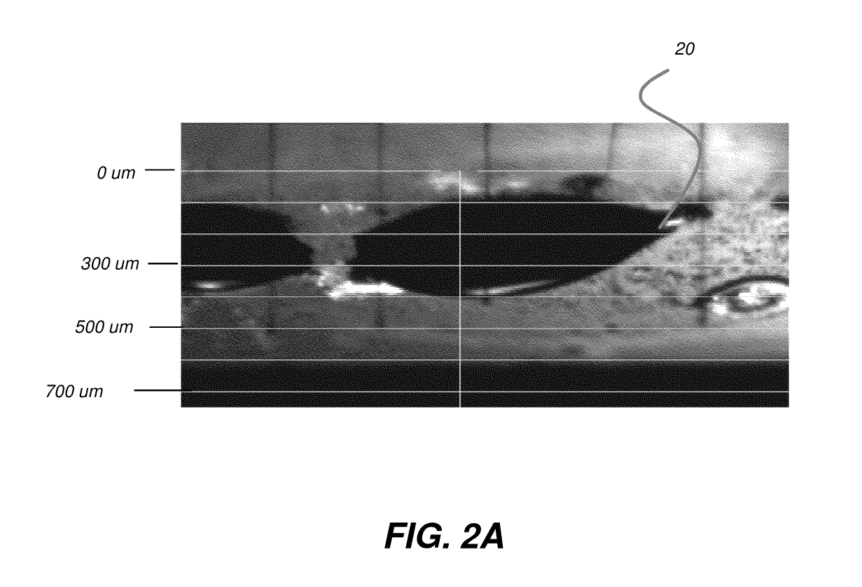

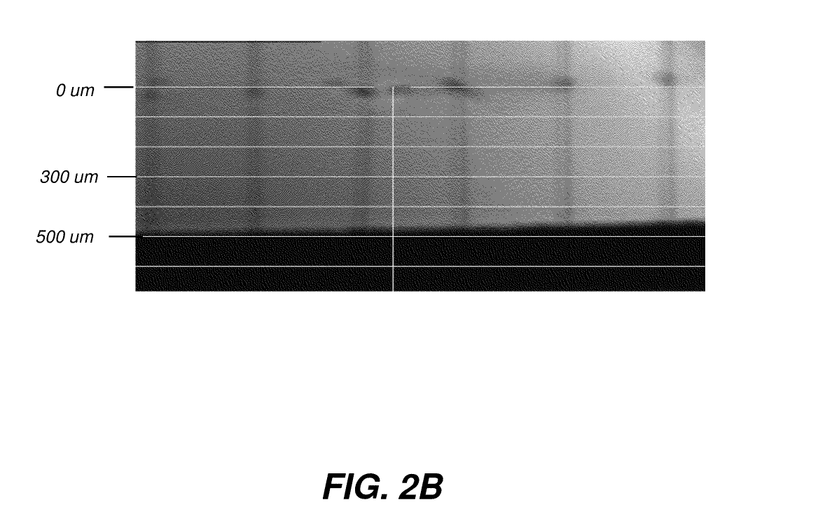

Viscosity for Comparative ink composition E was found to be 20.9 cP with a surface tension of 32.04 mN/m. Viscosity for Inventive ink composition F was found to be 20.7 cP and surface tension was 34.03 mN/m. As shown in FIGS. 2A (Comparative) and 2B (Inventive), ink jetting of each ink using the same Dimatix printer and the same printing protocol revealed differences in nozzle-plate wetting behavior similar to that observed for the higher polymer content experiment of Example 1. Use of the Inventive ink resulted in complete freedom from nozzle-plate flooding, whereas flooding is evident with the Comparative ink.

### EXAMPLE 5

### Inks Using Other Diol Monoethers

Ink Comparative F and ink Inventive G were prepared from Powder F which had a mean diameter of 51.0 nm and comprised 11.07% PVP. Ink Inventive G used 2-methoxyethanol (2ME), a glycol mono ether, as the diol monoether according to Table 3. Inks Comparative G and Inventive H were prepared from Powder G which had a mean diameter of 53.4 nm and consisted of 5.02% PVP by weight. Ink Inventive H used 2-ethoxyethanol (2EE) as the glycol ether according to Table 3. Physical properties and nozzle plate wetting were measure as in the examples above and the results are also included in Table 4.

TABLE 4

| | Wt. % | | Wt. % | Surface | | Nozzle |
|---|---|---|---|---|---|---|
| | Ethylene | Wt. % 1- | Glycol | Tension | Viscosity | Plate |
| Ink | Glycol | Butanol | Mono Ether | (mN/m) | (cP) | Wetting |
| Comp. F | 70 | 17.7 | 0 | 33.11 | 37.8 | Good |
| Inv. G | 67.9 | 8.8 | 10.9 2ME | 36.09 | 34.37 | Very Good |
| Comp. G | 70 | 17.7 | 0 | 33.17 | 26.45 | Fair |
| Inv. H | 59.2 | 7.4 | 21.1 2EE | 35.19 | 23.22 | Good |

It can be seen from Table 4 that inks comprising both 2-methoxyethanol and 2-ethoxyethanol give similar increases in surface tension and decreases in viscosity which result in improved jetting as shown in previous examples. In addition, nozzle plate wetting is improved.

### EXAMPLE 6

### Improved Image Quality and Conductivity

Inks Comparative G and Inventive H were printed onto an ink absorptive paper from Printed Electronic Laboratory LTD and 4 mil Kapton™, manufactured by DuPont, using the Dimatix DMP2800 printer. The printed pattern was a series of bars 95 mm long and 1 mm wide which had 3 mm square connection pads at each end. The prints were dried under mild vacuum at 50° C. for 1 hr. Two print passes were made for each pattern. Individual bars were converted to conductive tracks as part of the sintering process by flashing with a Sinteron 2000™ photonic curing system from Xenon Corporation equipped with Lamp B. A standard ohmmeter was used to measure resistances for a series of bars as a function of voltage supplied to the lamp. A plot of resistances for traces made from each ink on each substrate is shown in FIG. 3.

It is apparent from the plot that the ink comprising the glycol ether solvent gives lower resistance values than the comparative two solvent inks. The improvement is significant on both substrates. This improvement is consistent with an improvement in the quality of jetting which results in more uniform images. Images for inks Comparative G and Inventive H are shown in FIGS. 4A and 4B respectively. FIG. 4A shows many ink drops outside of the desired pattern consistent with misdirected jets caused by ink flooding the nozzle plate. FIG. 4B exhibits far fewer misdirected drops and a much more uniform, well defined coating.

The invention has been described in detail with particular reference to certain preferred embodiments thereof, but it will be understood that variations and modifications can be effected within the scope of the invention as described above, and as noted in the appended claims, by a person of ordinary skill in the art without departing from the scope of the invention. Sintering of the deposited ink, for example, can be performed photonically or using heat or other energy source.

What is claimed is:

1. A metal ink composition comprising:
copper nanoparticles having polymer shells;
a primary glycol;
an alcohol; and,
a diol monoether.

2. The ink composition according to claim 1 wherein the composition is characterized by a surface tension in the range of 34 to 37 mN/m.

3. The ink composition according to claim 1 wherein the composition is characterized by a viscosity of less than 41 cP.

4. The ink composition according to claim 1 wherein the polymer shell is of a material selected from at least one of the group consisting of polyvinylpyrrolidone, polyvinyl alcohol, methyl cellulose, polyethylene glycol, polyacrylic acid, polymaleic acid , and polymethylmethacrylate.

5. The ink composition according to claim 1 wherein the primary glycol is selected from at least one of the group consisting of ethylene glycol, propylene glycol, and 1,2-dihydroxybutane.

6. The ink composition according to claim 1 wherein the alcohol is selected from at least one of the group consisting of butanol, amyl alcohol, hexanol, heptanol, and octanol and their secondary, tertiary and branched isomers.

7. The ink composition according to claim 1 wherein the diol monoether is selected from at least one of the group consisting of 1-methoxy-2-propanol, 2-methoxy-ethanol, 2-ethoxy-ethanol, and 2-butoxy-ethanol.

8. The ink composition according to claim 1 wherein the weight fraction of copper nanoparticles in the ink composition is in the range of 5% to 17%.

9. The ink composition according to claim 1 wherein the weight fraction of polymer with respect to the polymer plus copper nanoparticles is in the range of 5% to 14%.

10. The ink composition according to claim 1 wherein the diol monoether is in the range of about 15% to about 21.1% by weight.

11. The ink composition according to claim 1 wherein the copper nanoparticles have diameter less than 200 nm.

12. A method for ink jet printing of conductive inks to form patterned copper conductive films comprising:
jetting of a copper nanoparticle ink having a surface tension in the range of 34 mN/m and 37 mN/m, and having a viscosity of less than or equal to 41 cP; and
sintering the printed ink to form a patterned conductive copper film.

13. The method for ink jet printing of conductive inks according to claim 121, wherein sintering is performed photonically.

14. The method for ink jet printing of conductive inks according to claim 12, wherein sintering is performed using heat.
